(19) United States
(12) Patent Application Publication
(10) Pub. No.: US 2011/0287390 A1
(43) Pub. Date: Nov. 24, 2011

(54) ARTISTS KIT

(76) Inventor: Aman Malhotra, Orange, CA (US)

(21) Appl. No.: 12/785,048

(22) Filed: May 21, 2010

(51) Int. Cl. G09B 11/10

(52) U.S. Cl. 434/84

(57) ABSTRACT

The present invention concerns itself with systems and methods for getting an image on a surface, such as a wall, in a fast, qualitative, and economical way. The present invention is automating the whole painting and/or printing process by giving users, such as parents or guardians, the option to paint a kids room with cartoon characters for example, by themselves, and save money and time in the process, and be happy with the results.

### BACKGROUND OF THE INVENTION

1. Field of the Invention

The present invention relates generally to artistic painting and printing and particularly to artistic painting and printing using templates.

2. Description of the Related Art

As of today, if we need to paint our kids room, with cartoon characters for example, and a quality outcome is desired, we need to hire a professional painter or artist to do the job, which cost thousands of dollars. Or, a less expensive alternative is to use paper and/or pencil tracing techniques, which is time consuming and the outcome may not be what one expects (see for example these online references: http://www.wallnutz.com/mural-painting-kits.html; http://www.elephantsonthewall.com/?gclid=CLvdgqXzvaECFQxZbAodRj5-tw; http://www.google.com/patents?id=pXoDAAAAEBAJ&printsec=abstract&zoom=4#v=onepage&q=&f=false).

In other words, the options presently available to parents on the market are expensive or time consuming, or both. Furthermore, using these existing techniques, painting by hand by a non-professional (e.g., a parent) is generally necessary, which further adds to the time spent with the project and may also jeopardize the quality of the final result.

The problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

### BRIEF SUMMARY OF THE INVENTION

The present invention solves the above enumerated problems. In terms of time management, with the help of the present invention's kit, a user (e.g., a parent) will not have to spend time painting by hand, or, on tracing the picture on the wall, but just stick the provided template on the wall and color. In a preferred embodiment the coloring will be achieved by spray painting.

In terms of cost reduction, with the help of the present invention's kit, a user (e.g., a parent) does not have to hire someone else to paint what is needed by their child. Parents can do this themselves on their own time and save the considerable amount of money that they would otherwise pay to someone else.

The present invention concerns itself with systems and methods for getting an image on a surface, such as a wall, in a fast, qualitative, and economical way. The present invention is automating the whole painting and/or printing process by giving users, such as parents or guardians, the option to paint a kids room with cartoon characters for example, by themselves, and save money and time in the process, and be happy with the results.

### BRIEF DESCRIPTION OF THE DRAWINGS

For exemplification purposes, and not for limitation purposes, embodiments of the invention are illustrated in the figures of the accompanying drawings, in which:

FIG. 1 illustrates a drawing of a cartoon character colored in three major area colors, color one 101, color two 102 and color three 103, and, color four 104 for the template bridges, and the optional outline color five 105, drawn on a sheet of drawing material 106, in accordance with an embodiment of the present invention.

FIG. 2 illustrates cutouts for color one 201 cut in a sheet of template material 207, and some template bridges 204, in accordance with an embodiment of the present invention.

FIG. 3 illustrates cutouts for color two 302 cut in a sheet of template material 307, in accordance with an embodiment of the present invention.

FIG. 4 illustrates cutouts for color three 403 cut in a sheet of template material 407, in accordance with an embodiment of the present invention.

FIG. 5 illustrates a drawing of a cartoon character colored in three major area colors, color one 501, color two 502 and color three 503, and the optional outline color five 505, drawn on a sheet of template material 507, and wherein, all distinctly colored areas are separated from each other, by a cut, in a puzzle-like manner, in accordance with several embodiments of the present invention.

### DETAILED DESCRIPTION OF THE INVENTION

What follows is a detailed description of specific embodiments of the invention in which the invention may be practiced. Reference will be made to the attached drawings, and the information included in the drawings is part of this detailed description. The specific embodiments of the invention, which will be described herein, are presented for exemplification purposes, and not for limitation purposes. It should be understood that structural and/or logical modifications could be made by someone of ordinary skills in the art without departing from the scope of the present invention. Therefore, the scope of the present invention is defined only by the accompanying claims and their equivalents.

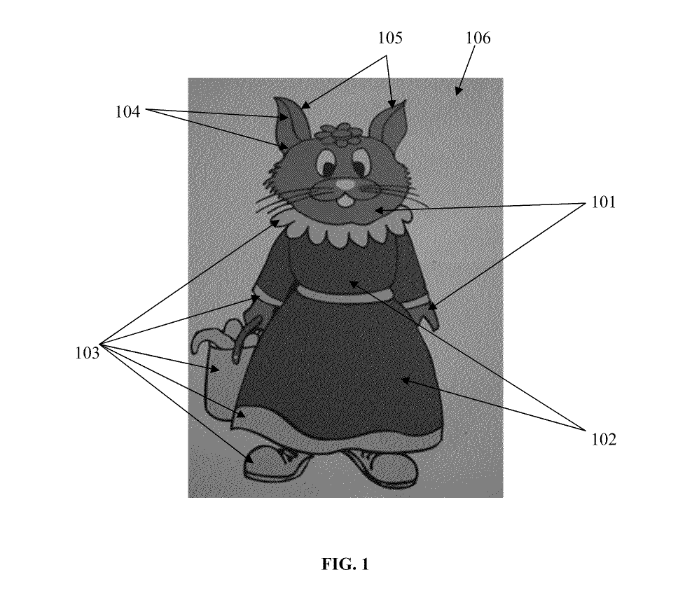

FIG. 1 illustrates a drawing of a cartoon character colored in three major area colors, color one 101, color two 102 and color three 103, and, color four 104 for the template bridges, and the optional outline color five 105, drawn on a sheet of drawing material 106, in accordance with an embodiment of the present invention. The colors used may be any colors, such as orange, yellow or pink. For example, color one 101 may be orange and color two 102 may be yellow. A copy of the color drawing of the cartoon character may be included in the present invention's kit for the user to see how the final painting will look like after using the kit. The sheet of drawing material 106 may be regular drawing paper, photographic paper or any other suitable material.

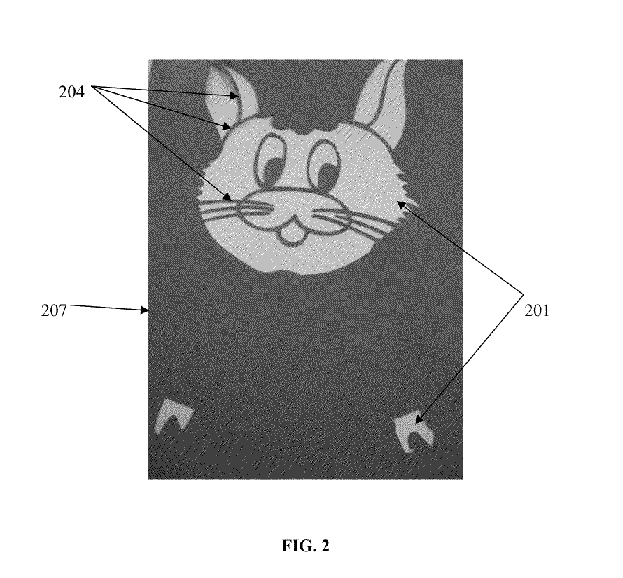

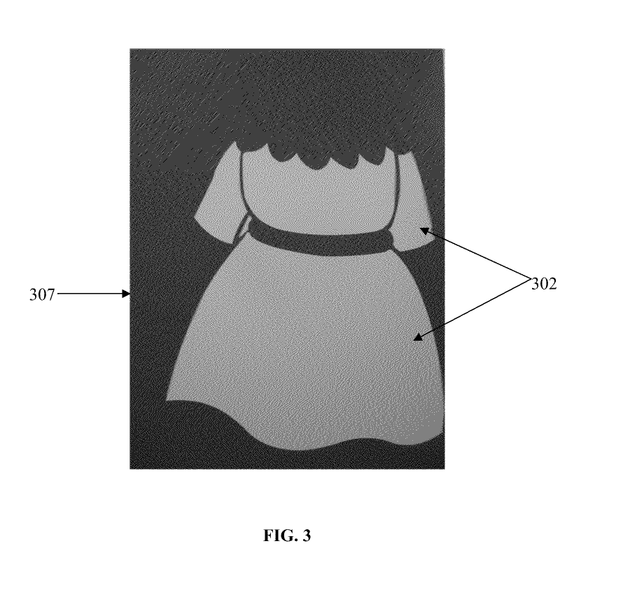

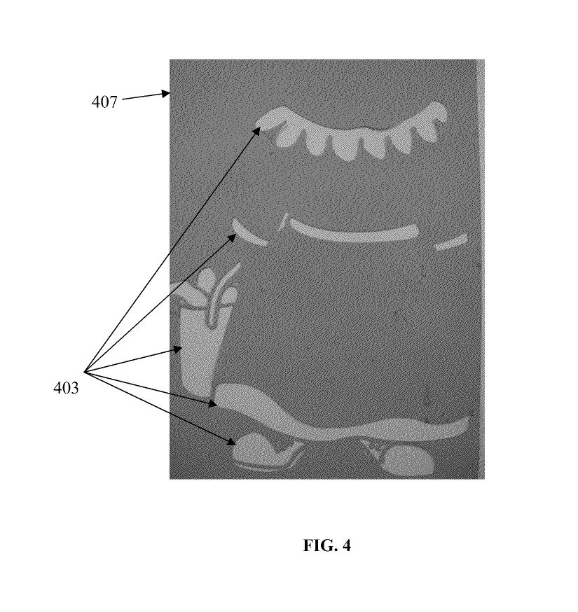

The drawing of the cartoon character may be used by a computer controlled machine to cut out each of the major color areas in separate sheets of template material. Therefore, in this illustrative example, three templates will be obtained, one for each of the three major area colors: one for color one, as seen in FIG. 2, one for color two, as seen in FIG. 3, and one for color three, as seen in FIG. 4. Optionally, a fourth template may be created for the outline color five 105, if it is desired to accentuate the shapes of the three major areas. It is also important to note, that the template bridges 105, which may be necessary in order to maintain the template functional, may be chosen, when possible, to also accentuate the shapes of the three major areas. In the final painting, the template bridges 105 will have the color of the surface (e.g., a wall, a T-shirt, the exterior of a vehicle, etc) on which the cartoon is painted. If desired, and additional template may be created for these bridges, to be used for painting over the bridges, hence covering the surface color with a different color. When possible, creating one single additional template (i.e., the fourth template) for both, the template bridges 104 and the outlines 105, may be desirable.

It is to be understood that for exemplification purposes three major color areas are discussed here. One of ordinary skills in the art would recognize that two, four, five or another number of major area colors may be used for any particular project, without departing from the scope of the present invention.

One important aspect of the present invention is that the template material for each particular color to be applied (e.g., color one), to the chosen surface (e.g., a wall, a T-shirt, the exterior of a vehicle, etc), has the same color as the color to be applied using that particular template. For example, if the cutouts 201 call for an orange color, the template material 207 will be colored in orange. That way, it would be very easy for the user of the template to paint the right color if the colors from the sample cartoon character drawings are desired. Obviously, the user may intentionally choose a different color if so desired.

To make it even easier for the user of the present invention's kit, to use the invention, spray paint cans with color paint, corresponding to the templates included in the kit, will also be included. So, for example, if the painting of a cartoon character calls for the painting of three areas, for example, one in orange, one in yellow and one in pink, the kit would include three templates, one for each area, and of the same color as the associated areas (one template in orange, one in yellow and one in pink), and three cans of spray paint, one for each of the three areas (one orange, one yellow and one pink).

To obtain the image of the cartoon character, the user would start by placing the first (orange) template (as the one in FIG. 2) on the respective surface (e.g. a wall), securing it using general purpose tape, and then, the user would use the spray paint can containing orange paint to apply orange color on the surface. For user's convenience, tape may be included in the present invention's kit. Next, the orange template would be removed, and when the orange color becomes dry, the second (yellow) template would be placed and secured on the surface, and yellow paint from the yellow spray can applied to the surface. Finally, the process would end by repeating the same steps using the pink template and the pink spray paint can. The templates can also have a number on them: number one for the first template (e.g. orange), number two on the second template (yellow), and so on.

The template material may be a relatively thick plastic or cardboard, or any other material with similar physical characteristics and suitable for this purpose. The thickness of the template material is important for avoiding smearing. The size of the template may be that of a common room wall (e.g., 8 Ft×8 Ft) to aid in painting one wall at the time. However, the size of the template may greatly vary, and, as one of ordinary skills in the art would recognize, changing the size of the template would not take such changes outside the scope of the present invention. For example, if the templates are used to paint and or print, a cartoon character for example, on a T-shirt, the templates would have to be correspondingly smaller in size. Furthermore, the template kit may be designed for the painting and/or printing of one object (e.g., cartoon character, house, plant, number, letter, etc) or a plurality of such objects.

Preferably, for convenience, increase quality of the final painting, and time efficiency, applying color to the chosen surface using the templates in the present invention's kit is achieved using spray paint cans. However, a user may choose to use other techniques (e.g., using a brush) or coloring materials (e.g., ink).

As one of ordinary skills in the art would recognize, the shapes or objects for which the templates can be used, are not limited to cartoon characters, which were used herein only for exemplification purposes. The shapes of letters, numbers, trees, stars, and the like, may be cut out from sheets of template material to create templates.

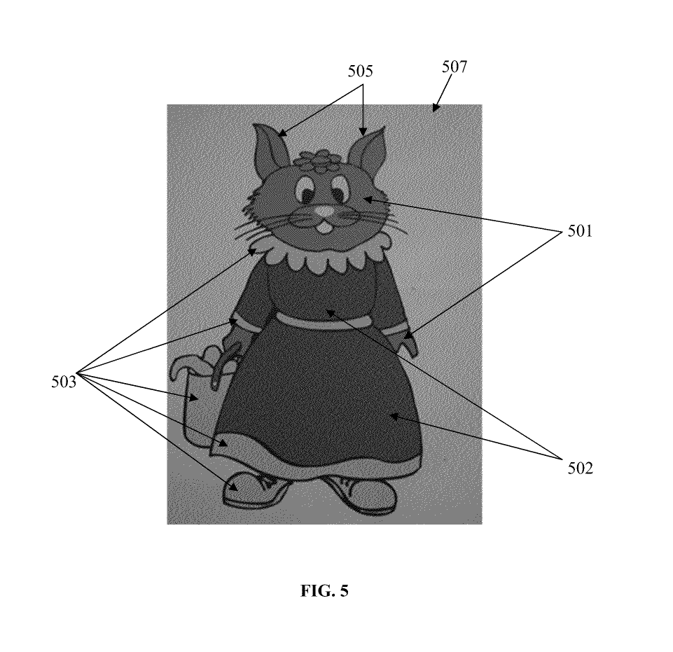

FIG. 5 illustrates a drawing of a cartoon character colored in three major area colors, color one 501, color two 502 and color three 503, and the optional outline color five 505, drawn on a sheet of template material 507, and wherein, all distinctly colored areas are separated from each other, by a cut, in a puzzle-like manner, in accordance with several embodiments of the present invention. This is another preferred embodiment of the present invention. Now instead of having three different template sheets described in the example above, the same result may be achieved using just one template sheet. This one single template sheet will be like a puzzle with pieces cut based on the color.

The user may want to start, for example, with color one 501 (e.g., orange). The user will tear the orange pieces from the puzzle and spray orange paint from the included orange spray can. After the orange color dries, the user will put back the orange color pieces on the respective surface (e.g., a wall, a T-shirt, the exterior of a vehicle, etc) with the tape provided, so that the next pieces can be removed and paint applied. For example, the user may continue by removing the pieces for color two 502 (e.g., yellow) and spray paint yellow using the included yellow spray paint. After the yellow color dries, the user will put back the yellow color pieces on the respective surface (e.g., a wall, a T-shirt, the exterior of a vehicle, etc) with the tape provided, so that the next pieces can be removed and paint applied. Finally, the user would finish the project by following the same steps for color three 503 (e.g., pink). Optionally, an additional template for the outline color 505 (e.g., gray) may be used.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the present invention. Therefore, the scope of this application is intended to cover alternate embodiments and/or equivalent variations of the specific embodiments illustrated and/or described herein. Hence, the scope of the present invention is defined only by the accompanying claims and their equivalents.

What is claimed is:

1. A system of painting and printing on a surface, objects having a plurality of colors, and comprising:
a template sheet with the images of the said objects on said template, and whereon, all distinctly colored areas of the said objects are separated from each other, by a cut, in a puzzle-like manner; and,
a plurality of spray paint cans, wherein, each spray paint can corresponds to one of the said plurality of colors.

2. The system of claim 1 further comprising a tape.

3. The system of claim 1, wherein said objects are cartoon characters.

4. The system of claim 1, wherein said surface is a wall.

5. The system of claim 1, wherein said template sheet contains the image of a single object.

6. A method of painting and printing on a surface, objects having a plurality of colors, and comprising the steps of:
placing on said surface a template sheet with the images of the said objects on said template, and whereon, all distinctly colored areas of the said objects are separated from each other, by a cut, in a puzzle-like manner;
separating from said template sheet the template sections corresponding to one of the said distinctly colored areas;
applying a coloring material on the said surface in the areas corresponding to the said template sections, the said coloring material having the same color as the said template sections;
when said coloring material is dry, inserting said template sections back into the said template sheet; and
repeating the above steps for all remaining said distinctly colored areas.

7. The method of claim 6, wherein said template sheet is secured to said surface by using tape.

8. The method of claim 6, wherein said objects are cartoon characters.

9. The method of claim 6, wherein said surface is a wall.

10. The method of claim 6, wherein said template sheet contains the image of a single object.

11. A method of painting and printing on a surface, objects having a plurality of colors, comprising the steps of:
placing on said surface a first template sheet whereon the cutouts in said first template sheet correspond to sections of said objects colored in a first color of said plurality of colors, said first template material being of the same color as the said first color;
applying a coloring material on the said surface in the areas corresponding to the said first template cutouts, the said coloring material having the same color as the said first color;
when said coloring material of said first color is dry, placing a second template sheet on said surface whereon the cutouts in said second template correspond to sections of said objects colored in a second color of said plurality of colors, said second template material being of the same color as said second color;
applying a coloring material on the said surface in the areas corresponding to the said second template cutouts, the said coloring material having the same color as the said second color; and
repeating the above steps for all remaining said plurality of colors.

12. The method of claim 11, wherein said first and second template sheets, and the subsequent template sheets if any, are numbered.
